(19) United States
(12) Patent Application Publication
(10) Pub. No.: US 2007/0097395 A1
(43) Pub. Date: May 3, 2007

(54) Image forming device

(76) Inventor: Akira Kaminogo, Osaka (JP)

Correspondence Address: GLOBAL IP COUNSELORS, LLP, 1233 20TH STREET, NW, SUITE 700, WASHINGTON, DC, 20036-2680, US

(21) Appl. No.: 11/259,143

(22) Filed: Oct. 27, 2005

(51) Int. Cl. G06F 3/12

(52) U.S. Cl. 358/1.13

(57) ABSTRACT

The image forming device comprises: a receiving means configured to receive a print job containing print data; an image formation processing means configured to convert the print data into bitmap data; a printing means configured to execute printing based on the bitmap data, the image forming device being further equipped with: a paper sensor configured and arranged to detect paper on a paper discharge tray; a storage means configured to store the bitmap data uniquely for each print job; and a control means configured to do the following when it is detected that paper remains in the paper discharge tray based on the output of the paper sensor: suspend the execution of printing of a received print job, store bitmap data obtained from the image formation processing means in the storage means, and read the bitmap data stored in the storage means and execute printing by means of the printing means based on the read bitmap data at a point in time when it is detected that the paper in the paper discharge tray has been removed based on the output of the paper sensor.

### FIELD OF THE INVENTION

The present invention relates to an image forming device configured to suspend the execution of a new print job when paper of an immediately previous print job remains on a paper discharge tray.

### BACKGROUND INFORMATION

There are existing image forming devices configured to suspend commencement of a print job until the paper discharged due to a previous print job has been removed from an output bin. Among such image forming devices, there is a known image forming device that is configured such that it can effectively prevent print jobs from accumulating. More specifically, in order to enable it to prevent print jobs from accumulating, this known image forming device is provided with an input processing means configured to accept print jobs and a detecting means configured to detect whether or not paper remains on the output bin. After image formation is executed with respect to paper in accordance with a first print job and the paper is discharged to the discharge bin, the image forming device suspends commencement of a second print job that follows the first print job until the paper of the first print job has been removed from the output bin and allows execution of the second print job to commence when a specific condition has been satisfied.

Since this image forming device only allows execution of the next print job when the specific condition is satisfied, the job continues to be suspended so long as the condition is not satisfied. Furthermore, when the suspension is canceled, it takes time for printing to resume

The present invention was conceived in view of these circumstances regarding the prior art and its object is to provide an image forming device that can execute the print processing of a theretofore suspended print job promptly after the suspended state of the print job has been canceled.

### SUMMARY OF THE INVENTION

The present invention applies to an image forming device comprising a receiving means configured to receive a print job containing print data, an image formation processing means configured to convert the print data into bitmap data, and a printing means configured to execute printing based on the bitmap data. An image forming device in accordance with the present invention is further equipped with a paper sensor configured and arranged to detect paper on a paper discharge tray, a storage means configured to store the bitmap data uniquely for each print job, and a control means configured to do the following when it is detected that paper remains in the paper discharge tray based on the output of the paper sensor: suspend the execution of printing of a received print job, store bitmap data obtained from the image formation processing means in the storage means, and read the bitmap data stored in the storage means and execute printing by means of the printing means based on the read bitmap data at a point in time when it is detected that the paper in the paper discharge tray has been removed based on the output of the paper sensor.

In the present invention, the control means is configured to execute a calibration of the printing means during a period when the execution of printing of a received print job is suspended.

In the present invention, the control means is configured to notify the user that the print job has been suspended when a user attempts to execute a received print job whose execution has been suspended.

In the present invention, the control means is configured to forcefully execute printing of a suspended print job when a user performs an operation instructing that printing of the print job be executed.

With the present invention, the most time consuming step of the print processing, namely, the image formation processing (i.e., the processing executed in order to convert the print data into bitmap data), is executed while the print job is being held in a suspended state and the suspended print job is stored as bitmap data. Consequently, when the suspension of the print job is canceled, printing can be resumed promptly.

Additionally, since the printing means is calibrated while a print job is in a suspended state and the printing means is not operating, a user who prints a suspended job can obtain printing results of consistent quality because the printing means will have just been calibrated when printing resumes.

Since the control means notifies the user that the print job has been suspended in cases where it has suspended a print job, the user can know with certainty that printing of the print job will not executed.

Since the image forming device is configured such that a user can go to the image forming device and forcefully execute printing of a suspended print job by performing an operation, suspended jobs can be prevented from accumulating.

### BRIEF DESCRIPTION OF THE DRAWINGS

FIG. 1 is a block diagram showing the constituent components of an embodiment of the present invention.

FIG. 2 is a flowchart showing the operation of the device shown in FIG. 1.

### DETAILED DESCRIPTION OF THE PREFERRED EMBODIMENTS

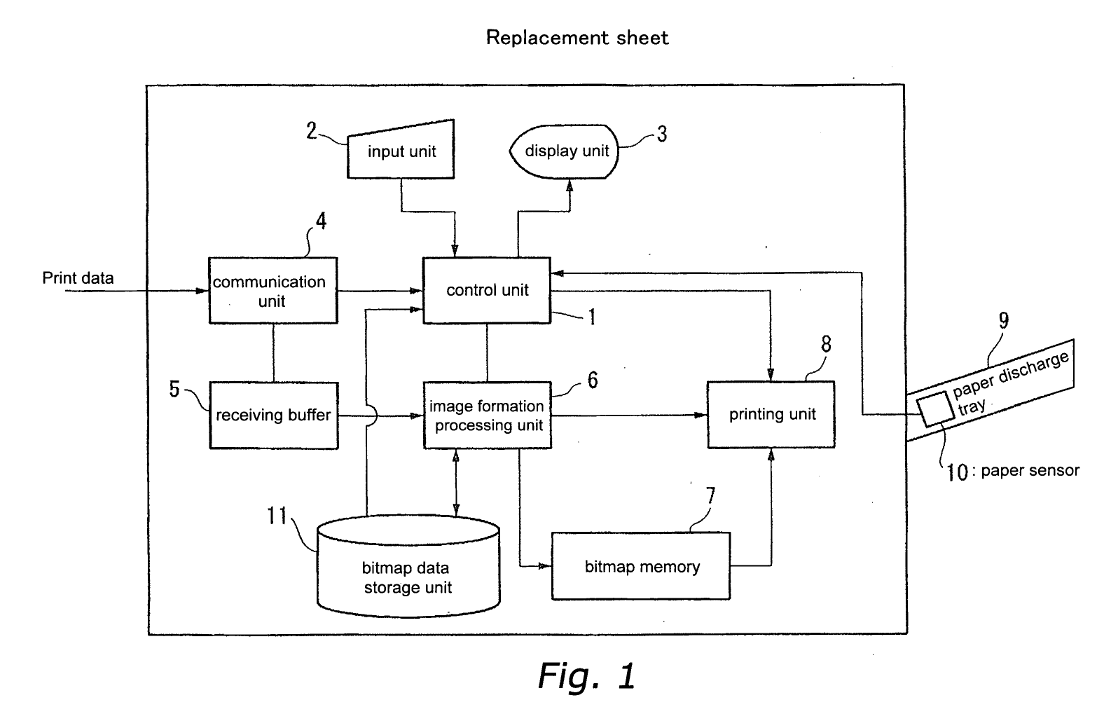

An image forming device in accordance with an embodiment of the present invention will now be described with reference to the drawings. FIG. 1 is a block diagram showing the constituent components of the embodiment. In the figure, the component indicated with the reference numeral 1 is a control unit configured to control the processing executed by and the operations performed by the image forming device in a centralized manner. The component indicated with the reference numeral 2 is an input unit equipped with numeric keys, function keys, a touch panel, etc. The component indicated with the reference numeral 3 is a display unit consisting of a liquid crystal display device or the like. The component indicated with the reference numeral 4 is a communication unit configured to conduct data communications between the image forming device and a host computer (not shown) in order to receive print data from the host computer. The print data mentioned here are intermediate data described in a page description language and are outputted from a printer driver running on the host computer. The component indicated with the reference numeral 5 is a receiving buffer configured to temporarily store print data received via the communication unit 4. The component indicated with the reference numeral 6 is an image formation processing unit configured to convert the bitmap data stored in the receiving buffer 5 into bitmap data. The component indicated with the reference numeral 7 is a bitmap memory configured to store bitmap data converted by the image formation processing unit 6. The component indicated with the reference numeral 8 is a printing unit configured to read the bitmap data stored in the bitmap memory and print the image described by the bitmap data by transferring the image to paper. The component indicated with the reference numeral 9 is a paper discharge tray configured and arranged to receive paper discharged from the printing unit 8 after being printed upon. The component indicated with the reference numeral 10 is a paper sensor configured and arranged to detect if paper that has been discharged remains on the paper discharge tray 9 and to issue a signal indicating the fact that paper exists when discharged paper exists on the paper discharge tray 9. The component indicated with the reference numeral 11 is a bitmap data storage unit configured to store the bitmap data converted by the image formation processing unit 6 uniquely for each print job and consists of a hard disk drive or the like.

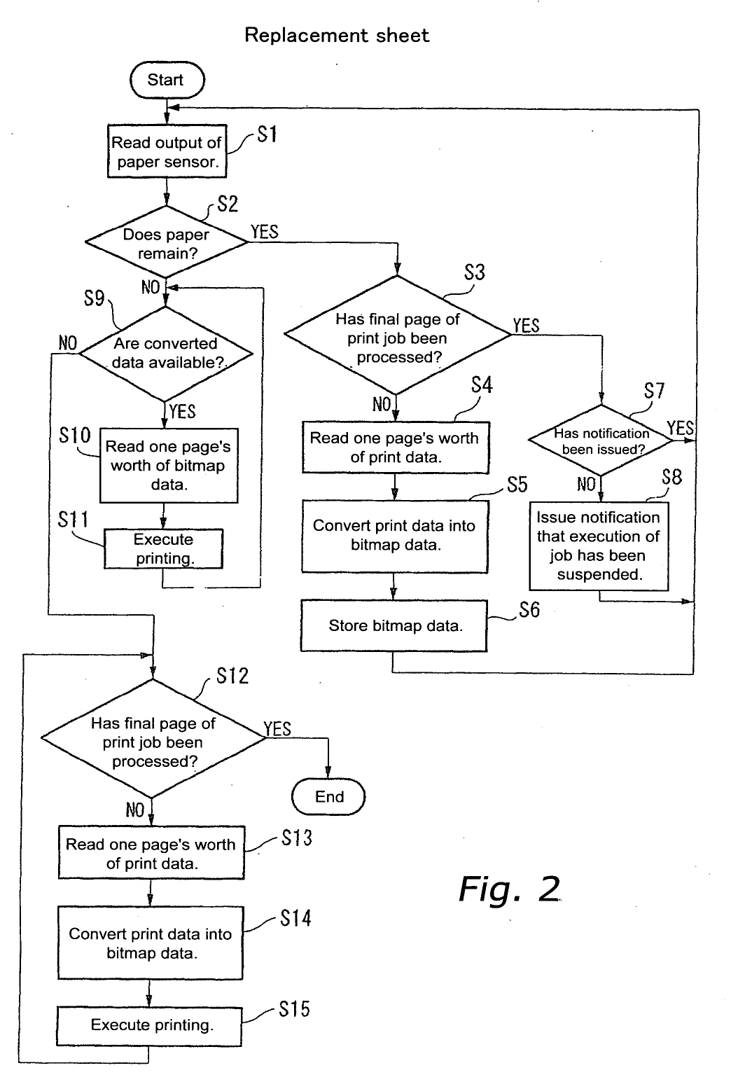

The operation of the image forming device shown in FIG. 1 will now be described with reference to FIG. 2. FIG. 2 is a flowchart describing the operations performed by the image forming device in order to print one print job containing print data received from the host computer.

First, the communication unit 4 receives a print job containing print data from the host computer (not shown), temporarily stores the content of the print job sequentially in the receiving buffer 5, and notifies the control unit 1 that the print job has been received. Upon receiving the notification, the control unit 1 reads the output of the paper sensor 10 (step S1) and determines if paper exists on the paper discharge tray 9 (step S2). If it determines that paper remains on the paper discharge tray 9, the control unit 1 determines if the final page of the print job being processed has been processed (step S3). This determination is performed for the purpose of notifying the user that a print job has been suspended if such is the case. If the final page has not yet been processed, the control unit 1 instructs the image formation processing unit 6 to process the next page. Upon receiving this instruction, the image formation processing unit 6 reads one page's worth of print data from the receiving buffer 5 (step S4) and converts the read print data into bitmap data (step S5). The image formation processing unit 6 then stores the resulting bitmap data in the bitmap data storage unit 11 (step S6). When it stores the bitmap data in the bitmap data storage unit 11, the image formation processing unit 6 assigns an identification name and an identification number to the bitmap data that enable the print job and page number, respectively, to be identified.

Next, the control unit 1 reads the output of the paper sensor 10 again (step S1) and determines if paper exists in the paper discharge tray 9 (step S2). If paper still remains in the paper discharge tray 9, the control unit 1 repeats the processing whereby the print data is converted into bitmap data until the final page is processed and stores the bitmap data in the bitmap data storage unit 11. When the processing of the final page has been completed, the control unit 1 notifies the user who executed the print job that execution of the print job has been suspended by issuing an electronic mail or other notification to the user's host computer (step S8). The control unit 1 ensures that only one notification is sent with respect to each individual print job by checking if a notification has already been sent (step S7).

By means of these processing operations, bitmap data obtained by converting print data is stored in the bitmap data storage unit 11. If paper still remains on the paper discharge tray 9 and a subsequent print job has been received by the receiving buffer 5 after this processing is finished, the control unit 1 executes the processing shown in steps S3 to S8 of FIG. 2 such that a plurality of print jobs is stored in the bitmap data storage unit 11.

If during the repeated execution of steps S3 to S8 it discovers that the paper has been removed from the paper discharge tray 9 (i.e., if it obtains a result of No at step S2), the control unit 1 determines if there is any data that has completed the process of being converted from print data to bitmap data and stored in the bitmap data storage unit 11 (step S9). If it determines that converted data is stored in the bitmap data storage unit 11, the control unit 1 instructs the image formation processing unit 6 to print the data stored in the bitmap data storage unit 11. Upon receiving this instruction, the image forming processing unit 6 reads one page's worth of the bitmap data from the bitmap data storage unit 11 (step S10) and stores the read bitmap data in the bitmap memory 7. The image formation processing unit 6 then instructs the printing unit 8 to execute printing of the one page's worth of bitmap data. Upon receiving this instruction, the printing unit 8 reads the bitmap data stored in the bitmap memory 7 and executes printing of one page (step S11). The control unit 1 repeatedly executes printing until there are no more converted data in one print job. As a result, the image forming device resumes execution of a print job that was suspended because printed paper resulting from the execution of an immediately preceding print job had not been removed from the paper discharge tray 9. Execution of only the print job that was received the earliest is resumed. Even if print jobs received second and later are stored in the bitmap data storage unit 11, printing of the next print job is not resumed so long as paper from the immediately preceding job (currently printing job) remains on the paper discharge tray 9.

After it has printed all of the converted data, the control unit 1 determines if the final page of the print job has been processed (step S12). In other words, the control unit 1 determines if execution of all of the already-converted data was sufficient to complete the printing of the entire print job. If it determines that the final page has not yet been processed, the control unit 1 instructs the image formation processing unit 6 to process the next page. Upon receiving this instruction, the image formation processing unit 6 reads one page's worth of print data from the receiving buffer 5 (step S13), coverts the read print data into bitmap data (step S14), and stores the bitmap data obtained by means of the conversion in the bitmap memory 7. Then, the image formation processing unit 6 instructs the printing unit 8 to execute printing of the one page's worth of bitmap data. Upon receiving this instruction, the printing unit 8 reads the bitmap data stored in the bitmap memory 7 and executes printing of one page (step S15). The control unit 1 repeatedly executes printing until there are no more print data in one print job. After the final page of the print job is printed, the control unit 1 ends the processing routine.

In this way, the most time consuming step of the print processing, namely, the image formation processing (i.e., the processing executed in order to convert the print data into bitmap data), is executed while the print job is being held in a suspended state and the suspended print job is stored as bitmap data. Consequently, when the suspension of the print job is canceled, printing can be resumed promptly.

When execution of a print job has been suspended, the operation of the image formation processing unit 6 is limited solely to writing bitmap data to the bitmap data storage unit 11. Consequently, it is acceptable to configure the image forming device such that the printing unit 8 is calibrated while the printing operation is suspended and the printing unit 8 is not operating. By executing such a calibration, a user who prints a suspended job can obtain printing results of consistent quality because the printing unit 8 will have just been calibrated when printing resumes.

Additionally, it is acceptable to configure the image forming unit such that a user can operate the input unit 2 so as to select a suspended job display function, thereby causing the control unit 1 to read data of the print jobs that have been stored in the bitmap data storage unit 11 and whose print operation has been suspended and display information that enables the suspended print jobs to be identified (i.e., job identification name, name of user who transmitted the job, etc.) on the display unit 3. It is also acceptable to configure the image forming unit such that any one of the suspended print jobs can be forcefully printed by operating the input unit 2 in such a manner as to select one of the print jobs displayed on the display unit 3. In this way, the image forming device can be configured such that a user can go to the image forming device and print a suspended print job by operating the input unit 2. Since the user must go to the image forming device in order to instruct the device to print, the user can readily obtain his or her own printed matter without that printed matter becoming intermixed with the printed matter remaining on the paper discharge tray.

It is also acceptable to configure the image forming device such that forced printing of a suspended print job is initiated from a user's terminal. In such a case, a monitoring tool for monitoring the suspended print jobs is installed in the user's terminal. In order to print a suspended print job, the user selects the desired print job using the monitoring tool and sends a print command to the image forming device. The image forming device receives the command and executes printing of the bitmap data corresponding to the selected print job. With this configuration, the amount of time the user spends waiting can be shortened because the image forming device begins printing by the time the user arrives at the image forming device.

The notification that a print job has been suspended shown in FIG. 2 (step S8) can be accomplished by a means other than electronic mail. For example, the notification can be conducted by means of a monitoring tool for monitoring suspended print jobs that is installed in the user's terminal.

It is also acceptable to configure the image forming device such that when printed paper resulting from a print job remains on the paper discharge tray 9, the name of the user who executed that print job is displayed on the display unit 3. Such a configuration would make it possible to determine who has forgotten to retrieve his or her printed matter.

It is also acceptable to create a program configured to accomplish the functions of the processing units shown in FIG. 1, record the program on a recording medium that can be read by a computer, install the program recorded on the recording medium into a computer system, and run the program on the computer system in order to execute print job management processing. The “computer system” mentioned here is assumed to include an operating system as well as peripheral devices and other hardware. Also, examples of a “recording medium that can be read by a computer” include such a portable medium as a flexible disk, a magnetic optical disk, a ROM, or a CD-ROM or such a storage device as a hard disk installed in the computer system. The “recording medium that can be read by a computer” can also be a server in a case where the program is transmitted via the internet or other network or via a telephone circuit or other communication circuit. Furthermore, the “recording medium that can be read by a computer” can also be something that holds the program temporarily, such as a volatile memory (RAM) internal to the client computer system.

It is also acceptable for the aforementioned program to be transmitted from a computer system having a memory device or the like in which the program is stored to another computer system through a transmission medium or by means of a transmission wave in a transmission medium. The “transmission medium” for transmitting the program is a medium possessing the ability to transmit information, e.g., the internet or other network (communication network) or a telephone circuit or other communication circuit (communication line). Furthermore, it is acceptable for the program to be configured to accomplish a portion of the aforementioned functions. Moreover, it is also acceptable for the program to be handled as a difference file (difference program) that can accomplish the aforementioned functions by operating in combination with a program that is already stored in the computer system.

What is claimed is:

1. An image forming device comprising a receiving means configured to receive a print job containing print data, an image formation processing means configured to convert the print data into bitmap data, and a printing means configured to execute printing based on the bitmap data, the image forming device being further equipped with:
a paper sensor configured and arranged to detect paper on a paper discharge tray;
a storage means configured to store the bitmap data uniquely for each print job; and
a control means configured to do the following when it is detected that paper remains in the paper discharge tray based on the output of the paper sensor:
suspend the execution of printing of a received print job,
store bitmap data obtained from the image formation processing means in the storage means, and,
at a point in time when it is detected that the paper in the paper discharge tray has been removed based on the output of the paper sensor, read the bitmap data stored in the storage means and execute printing by means of the printing means based on the read bitmap data.

2. The image forming device recited in claim 1, wherein the control means is configured to execute a calibration of the printing means during a period when the execution of printing of a received print job is suspended.

3. The image forming device recited in claim 1, wherein the control means is configured to notify the user that the print job has been suspended when a user attempts to execute a received print job whose execution has been suspended.

4. The image forming device recited in claim 1, wherein the control means is configured to forcefully execute printing of a suspended print job when a user performs an operation instructing that printing of the print job be executed.
